(19) United States
(12) Patent Application Publication
(10) Pub. No.: US 2010/0125387 A1
(43) Pub. Date: May 20, 2010

(54) SYSTEM OF INTEGRATED TELEMATICS SERVICE AND METHOD OF CONTROLLING THE SYSTEM

(75) Inventors: PARK Sehyun, Seoul (KR); KIM Gwangyeon, Seoul (KR); KIM Yong, Seoul (KR); UHM Yoon Sik, Seoul (KR); HWANG Zi on, Seoul (KR); JIN Ho Jin, Seoul (KR)

Correspondence Address: AMPACC Law Group, 3500 188th Street S.W., Suite 103, Lynnwood, WA, 98037, US

(73) Assignee: Chung-Ang University Industry-Academy Cooperation Foundation, Seoul (KR)

(21) Appl. No.: 12/569,092

(22) Filed: Sep. 29, 2009

(30) Foreign Application Priority Data
Nov. 17, 2008 (KR) 10-2008-0114007
Apr. 22, 2009 (KR) 10-2009-0035065

(51) Int. Cl. G06F 7/00; G01C 21/00; G06F 3/00

(52) U.S. Cl. 701/36; 701/200; 715/745

(57) ABSTRACT

Provided is an integrated telematics service system that may operate as an essential network interoperating gateway in a smart vehicle appropriate for a ubiquitous environment, and that includes: a network interface unit that receives a user input to process the user input based on an ontology modeling for the integrated telematics service, and interoperates with an external network of the smart vehicle; a knowledge based management unit that interoperates with the network interface unit to manage a policy and a schedule for a telematics service, an event occurring in the smart vehicle, and a schedule of a user; and a service unit that converts information associated with a navigation service or a multimedia service to a form suitable for an internal device of the smart vehicle, to perform a one-source-multi-use function.

### CROSS-REFERENCE TO RELATED APPLICATIONS

This application claims the benefit of Korean Patent Application No. 10-2008-0114007, filed on Nov. 17, 2008, and Korean Patent Application No. 10-2009-0035065, filed on Apr. 22, 2009, in the Korean Intellectual Property Office, the disclosures of which are incorporated herein by reference.

### BACKGROUND

1. Field of the Invention

Embodiments of the present invention relate to an integrated telematics service system that may enhance a user convenience using an essential network interoperating gateway of a smart vehicle appropriate for a ubiquitous environment, and may provide an automatic communication management service so that a user may utilize an optimal service in a next generation wired/wireless network interoperating system, and a method of controlling the integrated telematics service system.

2. Description of the Related Art

Examples of a conventional telematics service may include a navigation service and a regional information providing service, showing neighboring regions and information regarding attractions, that are provided from T-Mobile, a safety and security service and a real-time traffic information providing service that are provided from OnStar of GM, and the like. Domestic services may include, for example, a safety service, a traffic information service, a living information service, and a scheduling service that are provided from MOZEN, a two-way service of NateDrive that gathers and analyzes a traffic status in real time to suggest an optimal path using a voice and a graphic, and the like.

In the conventional telematics service, a device may be dependent on a service provider. Also, the conventional telematics service may provide simple services in which user information such as a user interest, a user behavioral pattern, a user profile, and the like is not considered, and thus may not be referred to as a smart telematics service. In addition, the conventional telematics service may provide a limited service based on a user's direct request, primary circumstance information, and the like. Accordingly, the conventional telematics service may not provide a user oriented service and may not support a combination between a heterogeneous network and devices.

### SUMMARY

An aspect of the present invention provides an integrated telematics service system in which a gateway may be independent from a service provider, and may interoperate with a network, and a method of controlling the integrated telematics service system.

Another aspect of the present invention also provides an integrated telematics service system that may have a network structure and thus may be independent from a mobile communication.

Another aspect of the present invention also provides a platform that is in an open structure so that a user may utilize consecutive multimedia services or automated convenient services via a gateway, and the user may generate the user's desired new service. Therefore, when the new service appears, the platform may be immediately applicable.

According to an aspect of the present invention, there is provided a system for an integrated telematics service, wherein the system operates as an essential network interoperating gateway in a smart vehicle appropriate for a ubiquitous environment, and the system includes: a network interface unit that receives a user input to process the user input based on an ontology modeling for the integrated telematics service, and interoperates with an external network of the smart vehicle; a knowledge based management unit that interoperates with the network interface unit to manage a policy and a schedule for a telematics service, an event occurring in the smart vehicle, and a schedule of a user; and a service unit that converts information associated with a navigation service or a multimedia service to a form suitable for an internal device of the smart vehicle, to perform a one-source-multi-use function.

The network interface unit may include: a vehicle information interface unit that is connected to an internal network of the smart vehicle to gather and manage vehicle information; a user interface unit that receives the user input to generate a feedback according to the user input; and a user network control unit that interoperates with the external network of the smart vehicle.

Also, the knowledge based management unit may include: a network management unit that provides a function of interoperating with the network interface unit; a knowledge based engine that manages the policy and the schedule for the telematics service; an event management unit that manages the event occurring in the smart vehicle; and a schedule management unit that manages the schedule and appointments of the user.

Also, the service unit may include: a navigation unit that is in charge of the navigation service; a conversion unit that converts input information; and a multimedia service unit that performs the one-source-multi-use function.

According to another aspect of the present invention, there is provided a method of controlling an integrated telematics service system, the method including: detecting a mobile device of a vehicle to authenticate a user via the mobile device; verifying a user profile of the authenticated user; generating a control signal to control an internal device of the vehicle based on the user profile; and controlling an internal device of the vehicle according to the control signal.

In this instance, the generating may include inferring a service, desired by the user, based on the user profile and a learned behavior pattern of the user.

Also, the controlling may include crawling information, desired by the user, in real time according to the control signal to convert the real-time crawled information to a form suitable for the internal device of the vehicle.

### EFFECT

According to embodiments of the present invention, a gateway may be independent from a service provider and may interoperate with a network. Also, it is possible to provide a user oriented telematics service, instead of providing a closed telematics service oriented for a mobile communication provider or an automobile industry. Accordingly, through a convergence of an online industry and an offline industry, that is, a convergence of the automobile industry and an information technology (IT) industry, a conversion from a closed research and development (R&D) structure to an open R&D structure initiated by the development industry, it is possible to expect a synergetic effect for the development of related industries. The above effect may be expanded to reduce social economical costs and enhance a quality of life by advancing a national traffic system.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an integrated telematics service system according to an embodiment of the present invention;

FIG. 2 is a diagram illustrating an example of an ontology modeling applicable in an integrated telematics service system according to an embodiment of the present invention; and

FIG. 3 is a flowchart illustrating a method of controlling an integrated telematics service system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

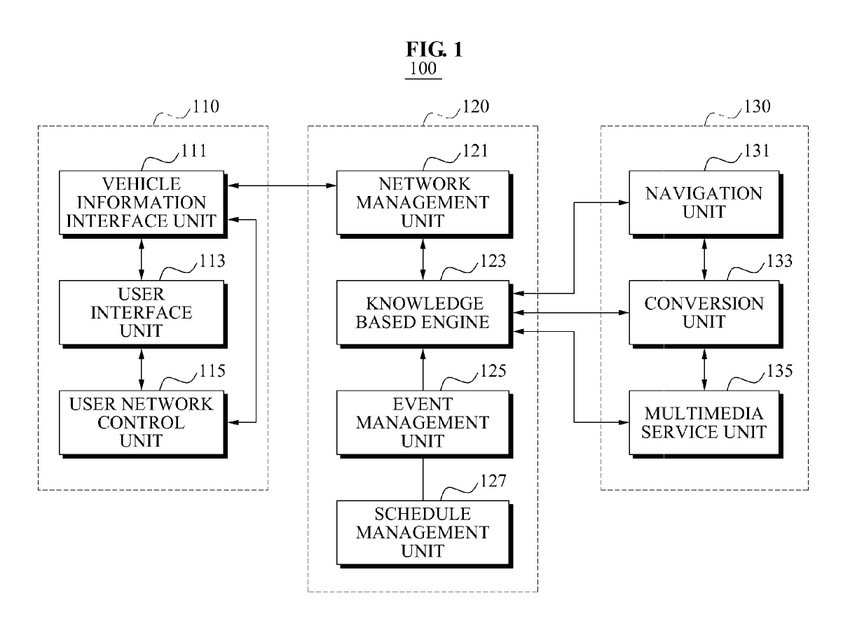

FIG. 1 is a block diagram illustrating an integrated telematics service system according to an embodiment of the present invention. Referring to FIG. 1, the integrated telematics service system 100 may include a network interface unit 110, a knowledge based management unit 120, and a service unit 130. Here, the integrated telematics service system 100 may operate as a network interoperating gateway, which is essential in a smart vehicle appropriate for a ubiquitous environment. For example, the smart vehicle may be a vehicle embedded with a computing system. Also, the smart vehicle may include a user friendly interface. According to an embodiment of the present invention, the smart vehicle appropriate for the ubiquitous environment may adaptively provide a user with a service and may provide the service without installing separate hardware.

The network interface unit 110 may include a vehicle information interface unit 111, a user interface unit 113, and a user network control unit 115. The network interface unit 110 may receive a user input to process the user input based on an ontology model for the integrated telematics service, and may interoperate with an external network of the smart vehicle.

The vehicle information interface unit 111 may be connected to an internal network of the vehicle to gather and manage vehicle information. In this instance, the internal network of the vehicle may be in various types of forms according to a user, an automobile manufacturer, and the like. Also, the internal network may be networking in a wired/wireless form. Vehicle information associated with the vehicle may include all types of information associated with the vehicle such as a convenience device, a driving device, and the like.

The user interface unit 113 may receive the user input to generate a feedback according to the user input. In this instance, the user input may include, for example, a button manipulation, a button touch, a voice control, a steering, and the like. Also, the feedback according to the user input indicates that the embedded computing system processes the user input based on the ontology modeling for the integrated telematics service, and informs the user about the processing result via a Heads-Up Display (HUD) or a speaker embedded in the vehicle, an activator, a motor, and the like. The feedback according to the user input may be provided using various types, for example, a voice guidance, directions during an emergency, an indication lamp, an indoor light, and the like. An example of topology modeling will be described in detail later.

The user network control unit 115 may manage an interoperation between the integrated telematics service system 100 and an external network of the vehicle. The external network may be a general communication network, for example, a high speed downlink packet access (HSDPA) network, a wireless broadband Internet (WiBro) network, a wireless local area network (WLAN), a low power radio frequency (RF) network, and the like. The interoperation between the integrated telematics service system 100 and the external network of the vehicle indicates a function of connecting a vehicle computer and the external network in order to enable a utilization of an external ontology database, and to provide an information gathering service, an automatic notice service, and the like.

The knowledge based management unit 120 may be provided in a middleware form. The knowledge based management unit 120 may include a network management unit 121, a knowledge based engine 123, an event management unit 125, and a schedule management unit 127. Here, the middleware form may be diversified such as a queue list structure using a database, a roll based inference structure, and the like. Therefore, when an appropriate event and schedule occurs, any type of middleware that can be input into a control unit (not shown) may be used. The knowledge based management unit 120 may interoperate with the network interface unit 110 to manage a policy and a schedule for a telematics service, an event occurring in the smart vehicle, and a schedule of the user.

The network management unit 121 may interoperate with the network interface unit 110.

The knowledge based engine 123 may manage the policy and the schedule for the telematics service. Here, the policy for the telematics service may be a service policy referred to by a computer of the vehicle, for example, an interoperability with the external network, an access to an external ontology database, a charging policy, and the like. The policy for the telematics service may need an algorithm that selects an appropriate policy according to a driver or a schedule of the driver, and may be constructed into various forms according to a manufacturer.

The event management unit 125 may manage the event occurring in the vehicle. For example, the event occurring in the vehicle may include an output event such as a warning event, a guidance event, and the like, and an input event such as a service and policy selection event, an event of manipulating a function while driving the vehicle, and the like.

The schedule management unit 127 may manage the user schedule, an appointment such as for an exchange of a vehicle part, and the like.

The service unit 130 may include a navigation unit 131, a conversion unit 133, and a multimedia service unit 135. The service unit 130 may convert information associated with a navigation service or a multimedia service to a form suitable for an internal device of the smart vehicle, to perform a one-source multi-use function.

The navigation unit 131 may be in charge of the navigation service and may provide a smart navigation function that includes an information crawling function based on a general Internet Protocol (IP) network. Unlike the conventional navigation service, the smart navigation service may automatically set a destination based on the user schedule or a user location, or may assist the user to set the destination.

The conversion unit 133 may convert information, input into the integrated telematics service system 100, to various types of information. Also, the conversion unit 133 may convert the crawled information to another form of information. Specifically, the conversion unit 133 may automatically gather various pieces of information, constructed into various formats on the Internet, according to a keyword and thereby convert the gathered information to a form that is suitable for providing the user with the gathered information. For example, the conversion unit 133 may gather map data on the Internet and convert the map data to a form that may be output in the navigation unit 131.

The conversion unit 133 may convert information associated with the navigation service and information associated with the multimedia service to a form that may be used in the internal device of the vehicle. For example, when a size of a content and a type of a codec used for creating the content for the multimedia service is unsuitable for the internal device, the conversion unit 133 may perform real-time transcoding for the content to provide the transcoded content to the internal device of the vehicle.

The multimedia service unit 135 may provide the one-source-multi-use function that enables multiple utilizations in a single authorized multimedia resource. The multimedia resource may use all types of multimedia resources regardless of setting a Digital Rights Management (DRM) and the like. Also, the one-source-multi-use function denotes a function that may automatically transcode and use a corresponding multimedia resource according to a device of outputting the multimedia resource.

The integrated telematics service system 100 may infer a profile based service. Specifically, the integrated telematics service system 100 may verify a user profile of the user through a user authentication, to infer a service desired by the user based on the user profile.

Here, the user file denotes a profile that is directly input by the user, and is generated by learning behavior patterns of the user.

Also, a user oriented service may be provided by inferring, dynamically constructing, and providing an optimal service based on a current status, a user preference pattern, the user profile, and the like, instead of simply providing set information.

According to an embodiment of the present invention, the integrated telematics service system 100 may provide information using real-time web crawling. Specifically, the integrated telematics service system 100 may crawl information, desired by a user, in real time based on a user profile that is learned and is stored in a corresponding database, and may provide the user with the real-time crawled information. Here, the information desired by the user may include, for example, a favorite genre of latest movie information, favorite music information, favorite channel information, and the like. The integrated telematics service system 100 may transcode the information desired by the user to a form suitable for a device installed in the vehicle, to thereby provide the transcoded information. For example, when an audio file gathered through real-time web crawling is coded in a form that cannot be played in an audio system of the vehicle, the integrated telematics service system 100 may transcode the gathered audio file into a playable form to thereby provide the transcoded audio file to the audio system.

As described above, according to an embodiment of the present invention, it is possible to maintain a best status by crawling information, desired by a user, in real time instead of simply providing stored data. Also, it is possible to search for and crawl various types of information beyond a mobile communication provider network, and to access a home or authorized content storage. Specifically, it may be economical since a one-source-multi-use function is provided.

According to an embodiment of the present invention, the integrated telematics service system 100 may control a smart device to provide a service. Specifically, in order to provide a user with a smart service, the integrated telematics service system 100 may dynamically control an air conditioner, a display device, an audio, a navigator, and the like.

According to an embodiment of the present invention, when a user gets into a vehicle while carrying the user's mobile device, for example, a device such as a cellular phone, the integrated telematics service system 100 may control an interoperation with the mobile device according to a predefined or preset rule with the mobile device. For example, the integrated telematics service system 100 may control a 3 G communication network installed in the cellular phone to be bridged using a Bluetooth interface installed in the cellular phone. When the integrated telematics service system 100 is connected with an external network, the integrated telematics service system 100 may perform intelligent operations according to its own schedule. Also, the integrated telematics service system 100 may synchronize a vehicle status database and a server for providing a vehicle care service, and display related information on a vehicle guidance device. For example, the integrated telematics service system 100 may display the information on an HUD, a dashboard, and the like, or provide a voice guidance, and the like.

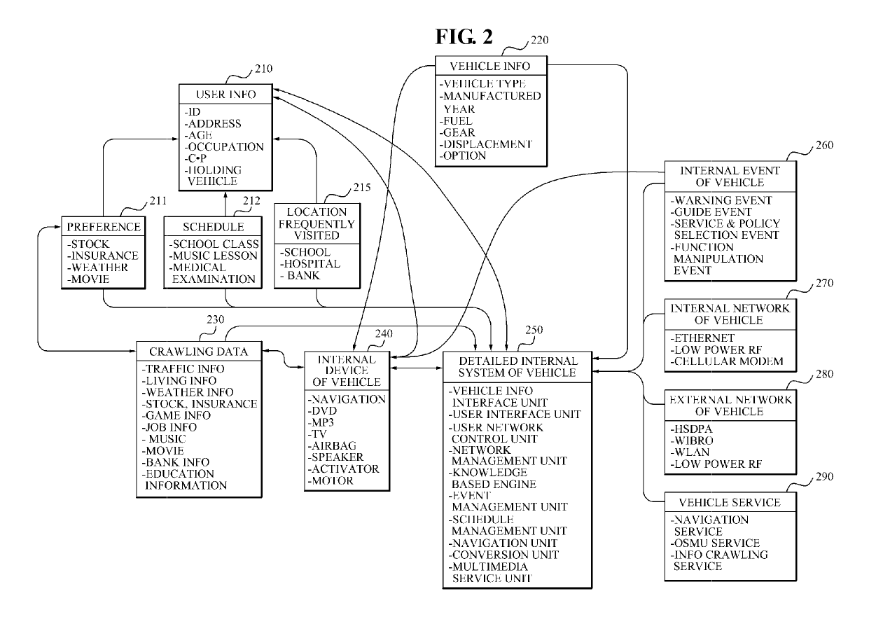

FIG. 2 is a diagram illustrating an example of an ontology modeling applicable in an integrated telematics service system according to an embodiment of the present invention.

Referring to FIG. 2, the example of the ontology modeling may be classified into nine classes for, for example, user information 210, vehicle information 220, crawling data 230, an internal device 240 of a vehicle, a detailed internal system 250 of the vehicle, an internal event 260 of the vehicle, an internal network 270 of the vehicle, an external network 280 of the vehicle, and a vehicle service 290.

The class for the user information 210 may provide various types of information associated with a user such as user identification (ID) information, a user preferred field and schedule, a location frequently visited by the user, and the like. The integrated telematics service system 100 may feed back the user information 210 according to a user input using the class for the user information 210. The class for the user information 210 may be classified into three subclasses for a preference 211, a schedule 212, and a located frequently visited 215. The subclass for the preference 211 may be connected to the class for the crawling data 230 to gather data regarding a field preferred by the user. The subclass for the schedule 212 may be connected to the schedule management unit 127 of FIG. 1 to store a user schedule and feed back the stored user schedule.

The class for the vehicle information 220 may provide basic information associated with the vehicle, and may be connected to the classes for the internal device 240 of the vehicle and the detailed internal system 250 of the vehicle.

The class for the crawling data 230 may provide the user with various types of information. For example, the class for the crawling data 230 may provide the user with various types of information regarding lifestyle, stocks, insurances, games, movies, and the like that the user prefers.

The class for the internal device 240 of the vehicle may provide internal device information of the vehicle such as a navigation, a digital video disc (DVD), an MP3, a TV, and the like that are connected to each other via the internal network of the vehicle.

The class for the detailed internal system 250 of the vehicle indicates that constituent elements of the integrated telematics service system 100 may be connected to classes of the ontology modeling.

The class for the internal event 260 of the vehicle defines various types of events that may occur in the vehicle, such as a warning event, a guidance event, and the like.

The class for the internal network 270 of the vehicle defines various types of networks that are associated with the user network control unit 115 of FIG. 1, and are currently available or will be available in the future.

The class for the external network 280 of the vehicle defines external networks that are currently available or will be available in the future. In this instance, the class for the external network 280 defines an interoperating relationship between a computer of the vehicle and the external network, in order to gather and utilize information in interoperation with the external network.

The class for the vehicle service 290 defines services that may be provided via the integrated telematics service system 100. For example, a navigation service may automatically set a destination based on the subclasses for the user schedule 212 or the location frequently visited 215, or may assist the user to set the destination.

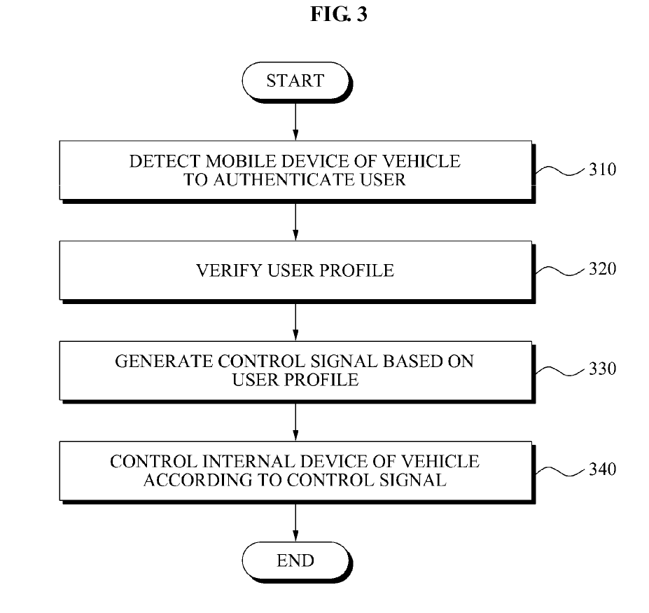

FIG. 3 is a flowchart illustrating a method of controlling an integrated telematics service system according to an embodiment of the present invention. The controlling method may be performed by the integrated telematics service system that is controlled via a single processor or a plurality of processors. The controlling method of FIG. 3 is only an example among various types of embodiments.

Referring to FIG. 3, in operation 310, the integrated telematics service system may detect a mobile device of a vehicle to authenticate a user via the mobile device. Here, the integrated telematics service system may authenticate the user based on user ID information. For example, the integrated telematics service system may access the mobile device via a Bluetooth interface of the mobile device to receive the user ID information from the mobile device.

In operation 320, the integrated telematics service system may verify a user profile of the authenticated user. Here, the user profile denotes a profile that is directly input by the user, and is generated by learning behavior patterns of the user.

In operation 330, the integrated telematics service system may generate a control signal for controlling an internal device, based on the user profile. Here, the control signal may be a signal for controlling an audio system installed in the vehicle. Also, the integrated telematics service system may infer a service desired by the user, based on the user profile and the user's learned behavior pattern. For example, the integrated telematics service system may infer a temperature in the vehicle, preferred by the user, and generate a control signal for setting the temperature in the vehicle based on weather information.

In operation 340, the integrated telematics service system may control an internal device of the vehicle according to the control signal. Here, the integrated telematics service system may crawl, in real time, user oriented information desired by the user, convert the crawled information to a form that is suitable for the internal device, and provide the crawled information via the internal device.

<Example of Providing a Service According to an Embodiment of the Present Invention>

Hereinafter, an example of providing a service using the integrated telematics service system 100 of FIG. 1 will be described.

1) Here, it is assumed that a scenario provided for a user is a scenario where the user is driving a vehicle with the integrated telematics service system 100 to a company.

2) When the user gets into the vehicle, the integrated telematics service system 100 may recognize the user. In this instance, the integrated telematics service system 100 may recognize the user as a registered driver, or may recognize the user by receiving user information that is stored in a mobile device of the user.

3) The integrated telematics service system 100 may automatically adjust the inside of the vehicle according to preferred characteristics of the recognized user. For example, when five users are registered in the integrated telematics service system 100, and the recognized user is a second user among the registered five users, the integrated telematics service system 100 may control internal devices of the vehicle to be suitable for the preferred characteristics of the user, for example, a seat height, a light, a music, and the like.

4) The integrated telematics service system 100 may verify a user profile of the recognized user and infer a service desired by the user. The integrated telematics service system 100 may crawl information desired by the user, based on the user profile that is stored in a database, and may provide the user with the crawled information.

5) When the user is not registered during a user recognition process, the integrated telematics service system 100 may control the internal device of the vehicle to not operate.

6) The integrated telematics service system 100 may automatically create a briefing about a company schedule, or may automatically set a temperature of the vehicle based on weather information. Also, when the user reaches a destination, the integrated telematics service system 100 may guide the user to an empty parking spot in interoperation with a parking lot network.

The above-described exemplary embodiments of the present invention may be recorded in computer-readable media including program instructions to implement various operations embodied by a computer. The media may also include, alone or in combination with the program instructions, data files, data structures, and the like. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for an integrated telematics service, wherein the system operates as an essential network interoperating gateway in a smart vehicle appropriate for a ubiquitous environment, and the system comprises:
a network interface unit that receives a user input to process the user input based on an ontology modeling for the integrated telematics service, and interoperates with an external network of the smart vehicle;
a knowledge based management unit that interoperates with the network interface unit to manage a policy and a schedule for a telematics service, an event occurring in the smart vehicle, and a schedule of a user; and
a service unit that converts information associated with a navigation service or a multimedia service to a form suitable for an internal device of the smart vehicle, to perform a one-source-multi-use function.

2. The system of claim 1, wherein the network interface unit comprises:
a vehicle information interface unit that is connected to an internal network of the smart vehicle to gather and manage vehicle information;
a user interface unit that receives the user input to generate a feedback according to the user input; and
a user network control unit that interoperates with the external network of the smart vehicle.

3. The system of claim 1, wherein the knowledge based management unit comprises:
a network management unit that provides a function of interoperating with the network interface unit;
a knowledge based engine that manages the policy and the schedule for the telematics service;
an event management unit that manages the event occurring in the smart vehicle; and
a schedule management unit that manages the schedule and appointments of the user.

4. The system of claim 1, wherein the service unit comprises:
a navigation unit that is in charge of the navigation service;
a conversion unit that converts input information; and
a multimedia service unit that performs the one-source-multi-use function.

5. The system of claim 4, wherein the navigation unit provides a smart navigation function that includes an information crawling function based on an Internet Protocol (IP) network.

6. The system of claim 4, wherein the conversion unit converts information, crawled from the external network, to a form that is output in the navigation unit.

7. The system of claim 1, wherein the knowledge based management unit is provided in a middleware form.

8. The system of claim 3, wherein the network management unit, the knowledge based engine, the event management unit, and the schedule management unit are provided in a middleware form.

9. The system of claim 1, wherein the knowledge based management unit verifies a user profile of the user, stored through a user authentication, to infer a service desired by the user based on the user profile.

10. The system of claim 1, wherein the knowledge based management unit crawls information, desired by the user, in real time to provide the user with the crawled information.

11. A method of controlling an integrated telematics service system, the method comprising:
detecting a mobile device of a vehicle to authenticate a user via the mobile device;
verifying a user profile of the authenticated user;
generating a control signal to control an internal device of the vehicle based on the user profile;
crawling information, desired by the user, in real time according to the control signal to convert the real-time crawled information to a form suitable for the internal device of the vehicle; and
providing the user with the converted information via the internal device of the vehicle.

12. The method of claim 11, wherein the generating comprises inferring a service, desired by the user, based on the user profile and a learned behavior pattern of the user.

13. The system of claim 5, wherein the knowledge based management unit crawls information, desired by the user, in real time to provide the user with the crawled information.
